(19) United States
(12) Patent Application Publication
(10) Pub. No.: US 2012/0044698 A1
(43) Pub. Date: Feb. 23, 2012

(54) LENS AND LAMP USING THE SAME

(75) Inventors: Han-Tsung Hsueh, New Taipei City (TW); Jia-Chyi Feng, New Taipei City (TW); Shih-Feng Chen, New Taipei City (TW)

(73) Assignees: Kinpo Electronics, Inc., New Taipei City (TW); Cal-Comp Electronics & Communications Company Limited, New Taipei City (TW)

(21) Appl. No.: 13/174,799

(22) Filed: Jul. 1, 2011

Related U.S. Application Data
(60) Provisional application No. 61/375,860, filed on Aug. 22, 2010.

(30) Foreign Application Priority Data
Dec. 6, 2010 (TW) 99142398

(51) Int. Cl. F21V 7/09

(52) U.S. Cl. 362/304

(57) ABSTRACT

A lens and a lamp using the lens are provided. The lamp includes a lampshade, a base assembled to the lampshade, a lens, and an LED light source. The lens configured on the base and located in the lampshade has a curved light incident surface, a first light incident surface surrounding the curved light incident surface, and a first and second light emitting surfaces. The curved light incident surface and the first light incident surface together constitute an accommodation space. The first light emitting surface is located above the curved light incident surface. The second light emitting surface is located at an outer side of the lens and corresponds to the first light incident surface located at an inner side of the lens. The second light emitting surface surrounds the first light emitting surface. The LED light source is configured in the accommodation space of the lens.

This application claims the priority benefit of U.S. Provisional Application Ser. No. 61/375,860, filed on Aug. 22, 2010. This application also claims the priority benefit of a Taiwan application serial no. 99142398, filed on Dec. 6, 2010. The entirety of each of the above-mentioned patent applications is hereby incorporated by reference herein and made a part of this specification.

### BACKGROUND OF THE INVENTION

1. Field of the Invention

The invention relates to a lamp. More particularly, the invention relates to a lens and a lamp using the lens.

2. Description of Related Art

Light emitting diode (LED) light sources have advantages of small volume occupancy and long life time, and therefore it is more common to apply the LED light sources in our daily lives.

It should be mentioned that the conventional LED light sources are directional. Therefore, the direct lightening region located in front of an LED light source has greater luminance than that of the indirect lightening region. The directional LED light sources are often applied to lamps characterized by great luminance instead of being applied to decorative lamps.

### SUMMARY OF THE INVENTION

The invention is directed to a lens with a simple look and low cost barrier.

The invention is further directed to a decorative lamp in which an LED serves as a light source.

The invention provides a lens. The lens has a curved light incident surface, a first light incident surface, a first light emitting surface, and a second light emitting surface. The first light incident surface surrounds the curved light incident surface, and the curved light incident surface and the first light incident surface together constitute an accommodation space. The first light emitting surface is located above the curved light incident surface. The second light emitting surface is located at an outer side of the lens and corresponds to the first light incident surface located at an inner side of the lens. Besides, the second light emitting surface surrounds the first light emitting surface.

The invention further provides a lamp that includes a lampshade, a base assembled to the lampshade, the aforesaid lens, and an LED light source. The lens is configured on the base and located in the lampshade. The LED light source is configured within the accommodation space of the lens.

According to an embodiment of the invention, the curved light incident surface is a curved concave.

According to an embodiment of the invention, the lens or the lamp using the lens further has an auxiliary surface that surrounds the first light incident surface. The auxiliary surface surrounds a circumference of the first light incident surface, and a diameter of the auxiliary surface is an outer diameter of the first light incident surface.

According to an embodiment of the invention, the first light incident surface is a plane, an inclined surface, or a curved surface.

According to an embodiment of the invention, the auxiliary surface is a circumferential surface of the first light incident surface.

According to an embodiment of the invention, the second light emitting surface has a first portion and a second portion, an inner diameter of the second portion is equal to an outer diameter of the first portion, and an outer diameter of the second portion is greater than the inner diameter of the second portion. The first portion of the second light emitting surface is an inclined surface or a curved concave. The second portion of the second light emitting surface is an inclined surface or a curved surface.

According to an embodiment of the invention, the lamp further includes a light source lens configured on the LED light source.

Based on the above, the lens of the invention has the simple look and low cost barrier. When the lens of the invention is used in the lamp, the light path of the LED light source can be adjusted, such that the LED light source is also applicable to the decorative lamp.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 and FIG. 2 are schematic views illustrating a lens at different viewing angles according to an embodiment of the invention.

FIG. 3 is a schematic cross-sectional view taken along a sectional line A-A′ in the lens depicted in FIG. 1.

FIG. 4 is a schematic view illustrating a lamp that uses the lens depicted in FIG. 1.

FIG. 5 illustrates light traces of the lens when the LED light source of the lamp depicted in FIG. 4 emits light.

FIG. 6 is a polar radiation view illustrating the beam shape when the lens depicted in FIG. 4 is made of polycarbonate (PC).

FIG. 7 is a cross-sectional view illustrating the beam shape when the lens is made of PC.

FIG. 8 is a polar radiation view illustrating the beam shape when the lamp has the lens that is made of polymethyl methacrylate (PMMA).

FIG. 9 is cross-sectional view illustrating the beam shape when the lamp has the lens that is made of PMMA.

FIG. 10 is a schematic view illustrating the LED light source on which a light source lens is further configured.

FIG. 11 is a cross-sectional view illustrating a lens according to a second embodiment of the invention.

FIG. 12 is a schematic view illustrating light traces of the LED light source and the lens depicted in FIG. 11.

FIG. 13 is a polar radiation view illustrating the beam shape when the lens depicted in FIG. 11 is made of PC.

FIG. 14 is a cross-sectional view illustrating the beam shape when the lens depicted in FIG. 11 is made of PC.

FIG. 15 is a polar radiation view illustrating the beam shape when the lamp has the lens that is made of PMMA.

FIG. 16 is cross-sectional view illustrating the beam shape when the lamp has the lens that is made of PMMA.

### DESCRIPTION OF EMBODIMENTS

### First Embodiment

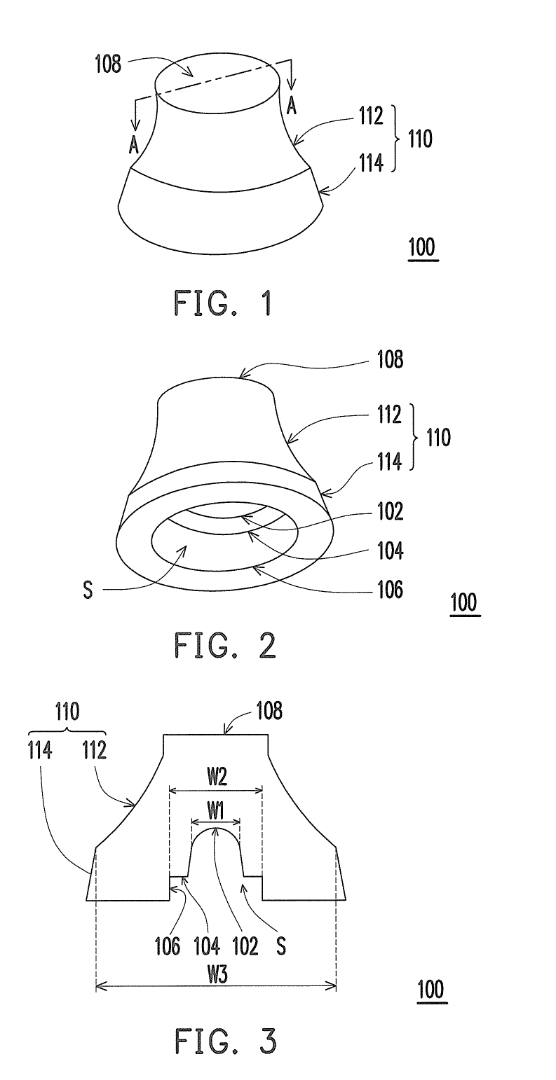

FIG. 1 and FIG. 2 are schematic views illustrating a lens at different viewing angles according to an embodiment of the invention. FIG. 3 is a schematic cross-sectional view taken along a sectional line A-A′ in the lens depicted in FIG. 1. With reference to FIG. 1, FIG. 2, and FIG. 3, the lens 100 of this embodiment has a curved light incident surface 102, a first light incident surface 104, a first light emitting surface 108, and a second light emitting surface 110. The first light incident surface 104 surrounds the curved light incident surface 102, and the curved light incident surface 102 and the first light incident surface 104 together constitute an accommodation space S. The first light emitting surface 108 is located above the curved light incident surface 102. The second light emitting surface 110 is located at an outer side of the lens 100 and corresponds to the first light incident surface 104 located at an inner side of the lens 100. Besides, the second light emitting surface 110 surrounds the first light emitting surface 108.

As shown in the cross-sectional view of FIG. 3, the curved light incident surface 102 is a curved concave in the lens 100, and the first light incident surface 104 is a plane. The lens 100 further has an auxiliary surface 106 that surrounds the first light incident surface 104. The auxiliary surface 106 surrounds a circumference of the first light incident surface 104. A diameter W1 of the curved light incident surface 102 is an inner diameter of the first light incident surface 104, and a diameter W2 of the auxiliary surface 106 is an outer diameter of the first light incident surface 104. The outer diameter W2 is greater than the inner diameter W1.

The second light emitting surface 110 has a first portion 112 and a second portion 114, and an inner diameter W3 of the second portion 114 is equal to an outer diameter of the first portion 112. As shown in the cross-sectional view of FIG. 3, the first portion 112 of the second light incident surface 110 is a curved concave in the lens 100, and the second portion 114 is an inclined plane according to this embodiment.

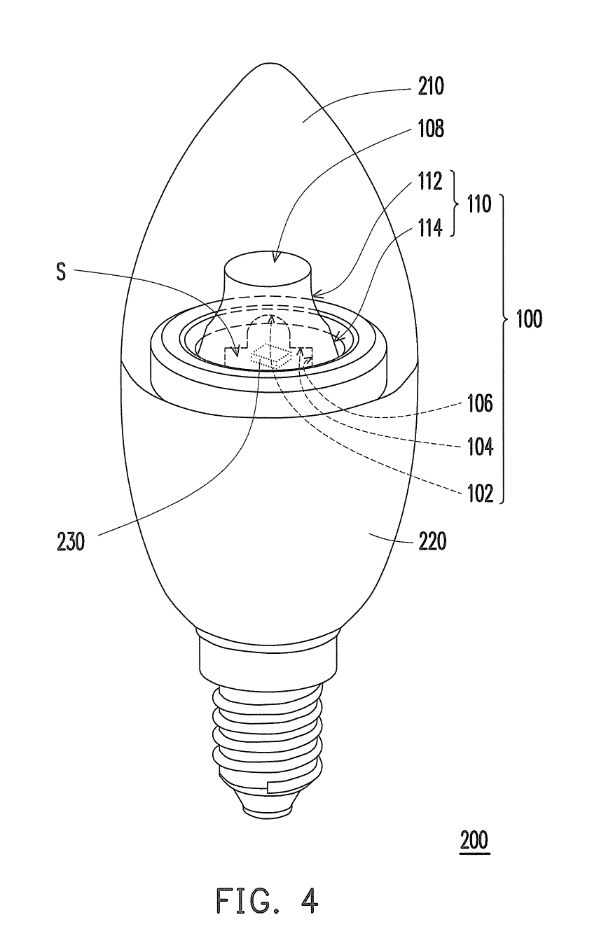

FIG. 4 is a schematic view illustrating a lamp that uses the lens depicted in FIG. 1. With reference to FIG. 2, FIG. 3, and FIG. 4, the lens 100 is applied to a decorative lamp 200. The lamp 200 includes a lampshade 210, a base 220, the aforesaid lens 100, and an LED light source 230. The base 220 is assembled to the lampshade 210. The lampshade 210 can be in any shape, which is determined based on the requirements of the decorative lamp 200. The lens 100 is configured on the base 220 and located in the lampshade 210. The LED light source 230 is placed into the accommodation space S of the lens 100 through an opening formed by the auxiliary surface 106.

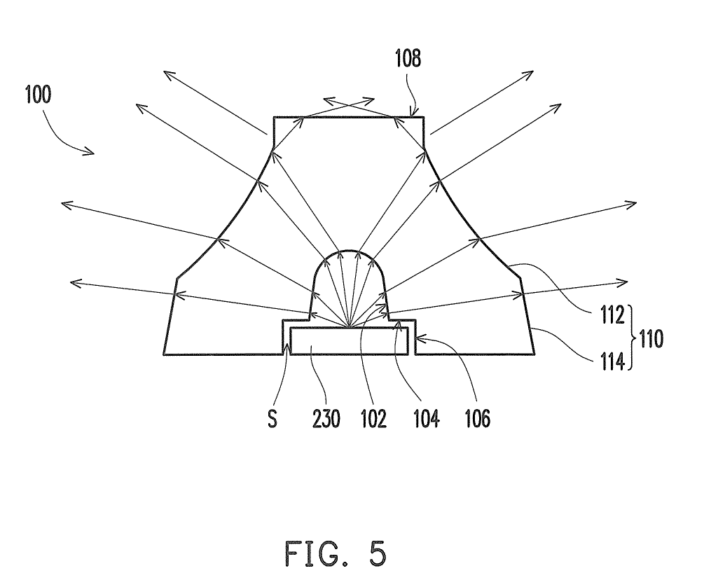

FIG. 5 illustrates light traces of the lens when the LED light source of the lamp depicted in FIG. 4 emits light. With reference to FIG. 5, when the LED light source 230 emits light, the light enters the lens 100 from the curved light incident surface 102. The radian of the curved light incident surface 102 is conducive to light refraction, such that the viewing angle of the lamp 200 can be enlarged when the light emitted by directional LED light source 230 is refracted by the curved light incident surface 102. The light refracted by the curved light incident surface 102 is further refracted by the second light incident surface 110 and then emitted out of the lens 100. Note that a portion of the light is refracted to the first portion 112 of the second light emitting surface 110 close to the first light emitting surface 108. The portion of the light is then completely reflected and emitted out from the first light emitting surface 108. Thereby, the light with uniform luminance can be emitted from the top of the lens 100.

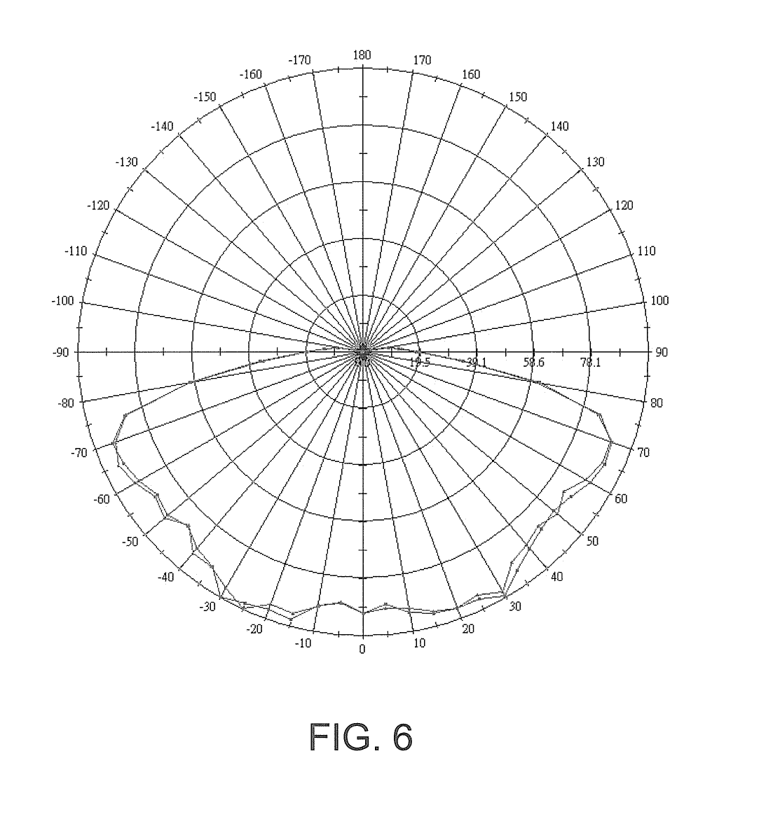

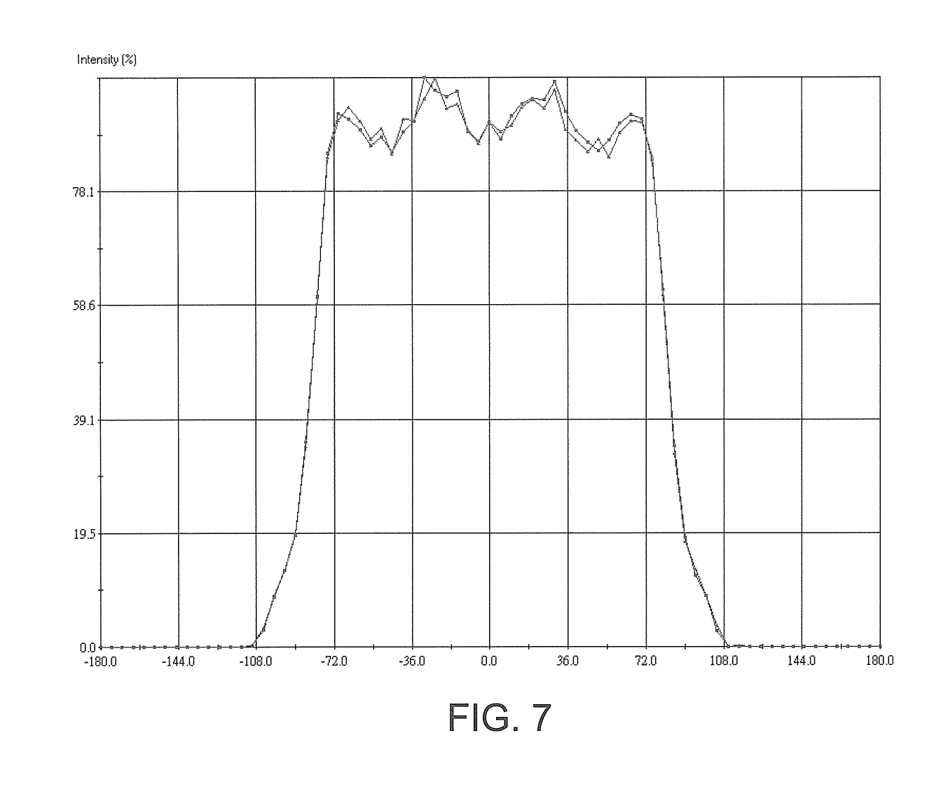

FIG. 6 is a polar radiation view illustrating the beam shape when the lamp depicted in FIG. 4 is applied. FIG. 7 is a cross-sectional view illustrating the beam shape when the lamp is applied. It can be observed from FIG. 6 and FIG. 7 that the viewing angle of the lamp 200 ranges from about 85 degrees to about −85 degrees. Namely, the range of the viewing angle of the lamp 200 is about 170 degrees in total. Within the range of the viewing angle of the lamp 200, the light is concentrated in the front, and the luminance is uniform.

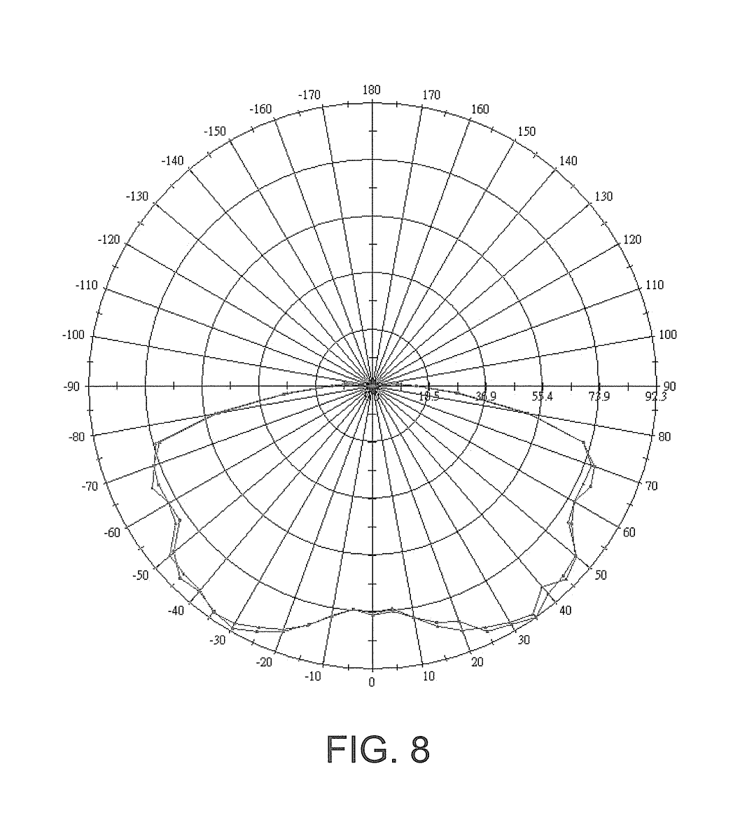

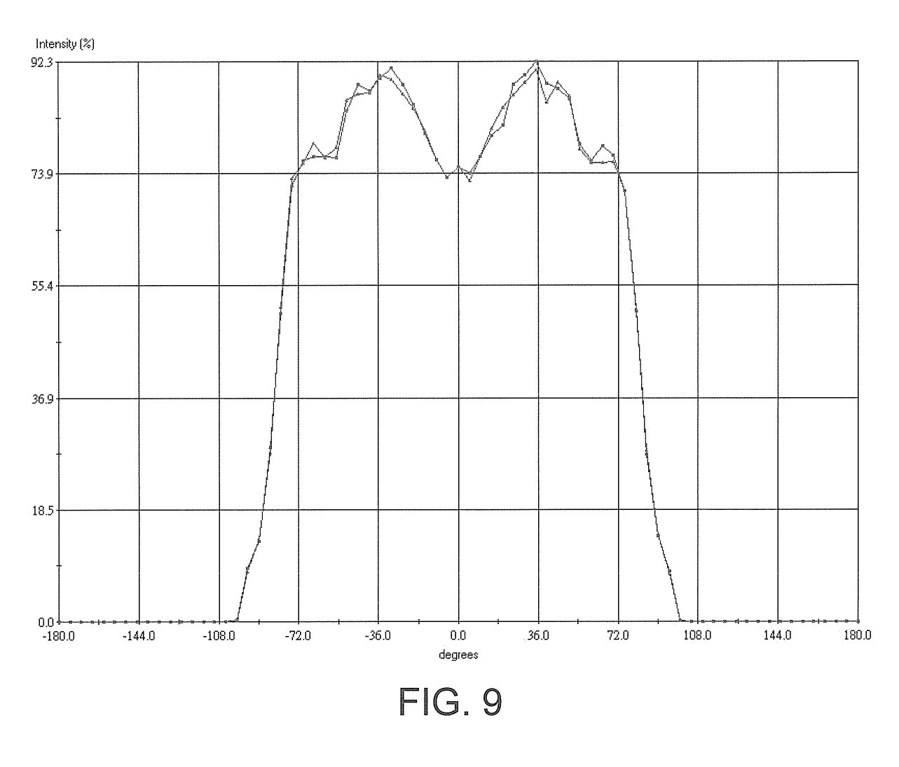

Note that the beam shape is subject to the material of the lens 100 in the lamp 200. In FIG. 6 and FIG. 7, the lens 100 is made of PC. FIG. 8 is a polar radiation view illustrating the beam shape when the lamp has the lens that is made of PMMA. FIG. 9 is cross-sectional view illustrating the beam shape when the lamp has the lens that is made of PMMA. In comparison with FIG. 6, FIG. 7 and FIG. 8, FIG. 9, the difference in the material of the lens poses an impact on the beam shape and uniformity of luminance. In view of the above, the material of the lens can be determined based on actual requirements in order to obtain the desirable beam shape and achieve favorable uniformity of luminance.

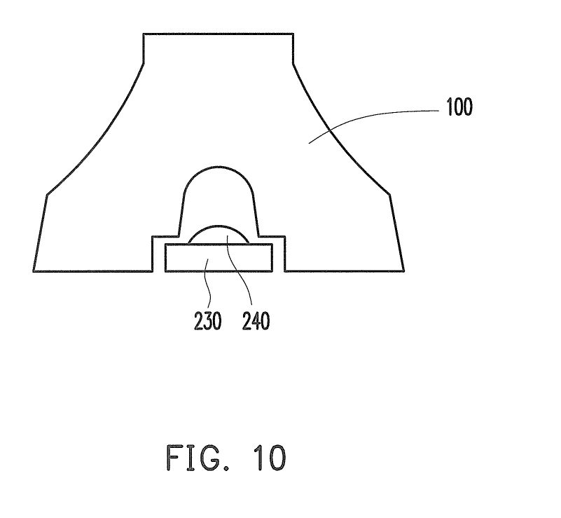

FIG. 10 is a schematic view illustrating the LED light source on which a light source lens is configured. With reference to FIG. 4 and FIG. 10, the lamp 200 can further include a light source lens 240 configured on the LED light source 230 and located between the LED light source 230 and the lens 100. The light source lens 240 in the lamp 200 can optimize the beam shape and uniformize the luminance.

### Second Embodiment

This embodiment is similar to the first embodiment. The difference therebetween lies in that the shape of the lens is slightly modified in this embodiment, and the decorative lamp of this embodiment can still have the wide viewing angle, favorable beam shape, and uniform luminance in comparison with the conventional decorative lamp.

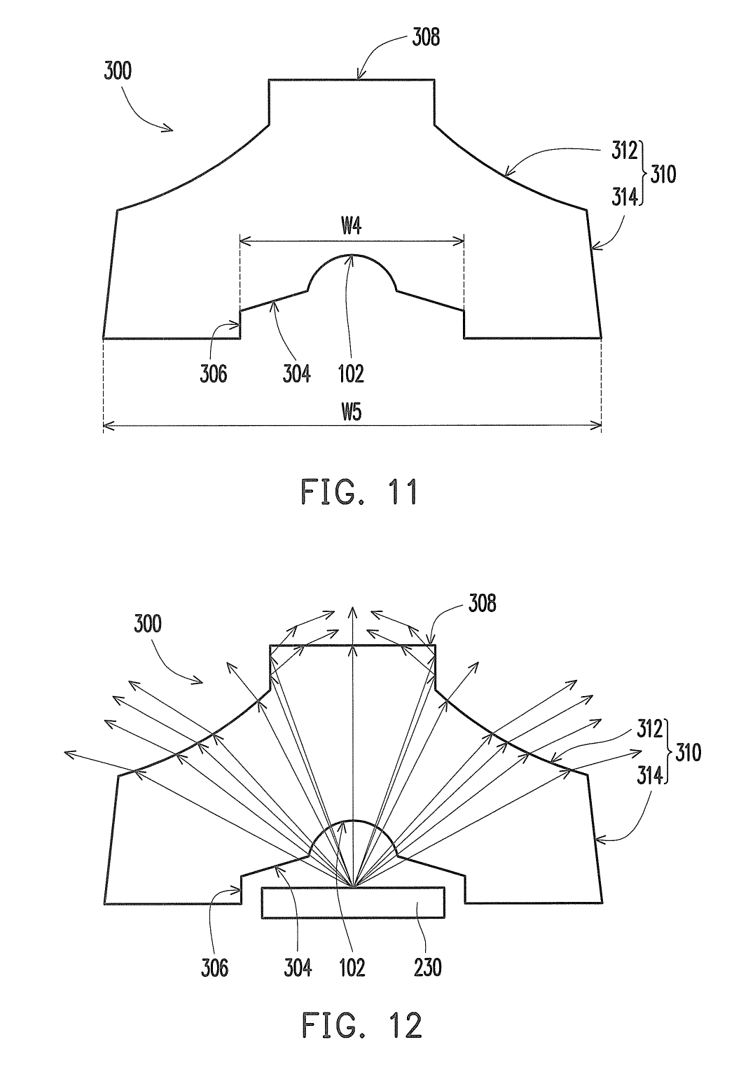

FIG. 11 is a cross-sectional view illustrating a lens according to a second embodiment of the invention. FIG. 12 is a schematic view illustrating light traces of the LED light source and the lens depicted in FIG. 11. Please refer to FIG. 11 and FIG. 12. It is shown in the cross-sectional view of FIG. 11 that the first light incident surface 304 of the lens 300 of this embodiment is an inclined surface, which is different from that of the first embodiment. Besides, the diameter of the auxiliary surface 306 is the outer diameter W4 of the first light incident surface 304, and the auxiliary surface 306 is a circumferential surface of the first light incident surface 304.

The diameter W5 of the second portion 314 of the second light emitting surface 310 is equal to the outer diameter of the first portion 312. As shown in the cross-sectional view of FIG. 11, the first portion 312 is a curved concave, and the second portion 314 is a plane.

It can be learned from FIG. 12 that the light emitted from the LED light source 230 enters the lens 300 through the curved light incident surface 102 and the first light incident surface 304. After the light is refracted by the curved light incident surface 102 and the first light incident surface 304, the light is refracted by the second light emitting surface 310 and then emitted out of the lens 300. Additionally, the light that is refracted by the curved light incident surface 102 to the first portion 312 of the second light emitting surface 310 close to the first light emitting surface 308 is completely reflected and then emitted from the first light emitting surface 308.

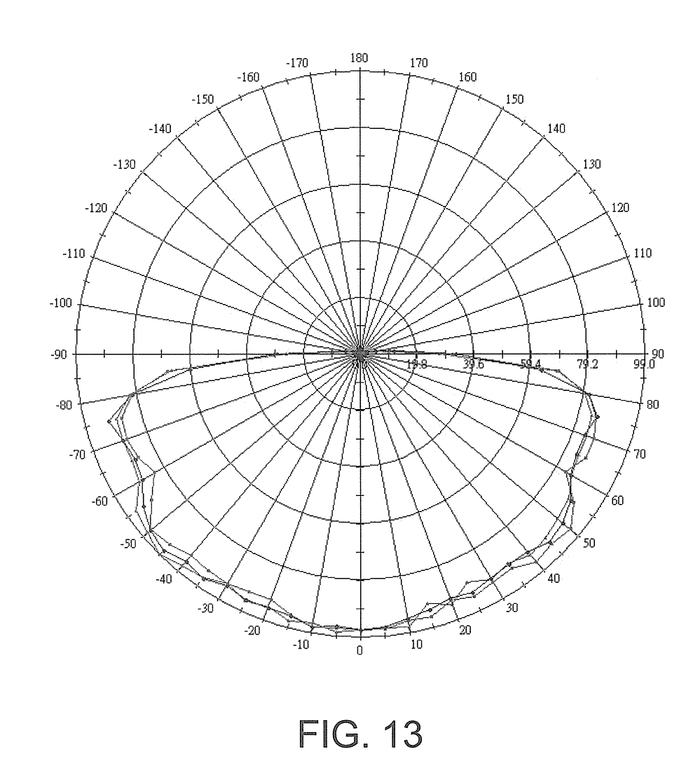

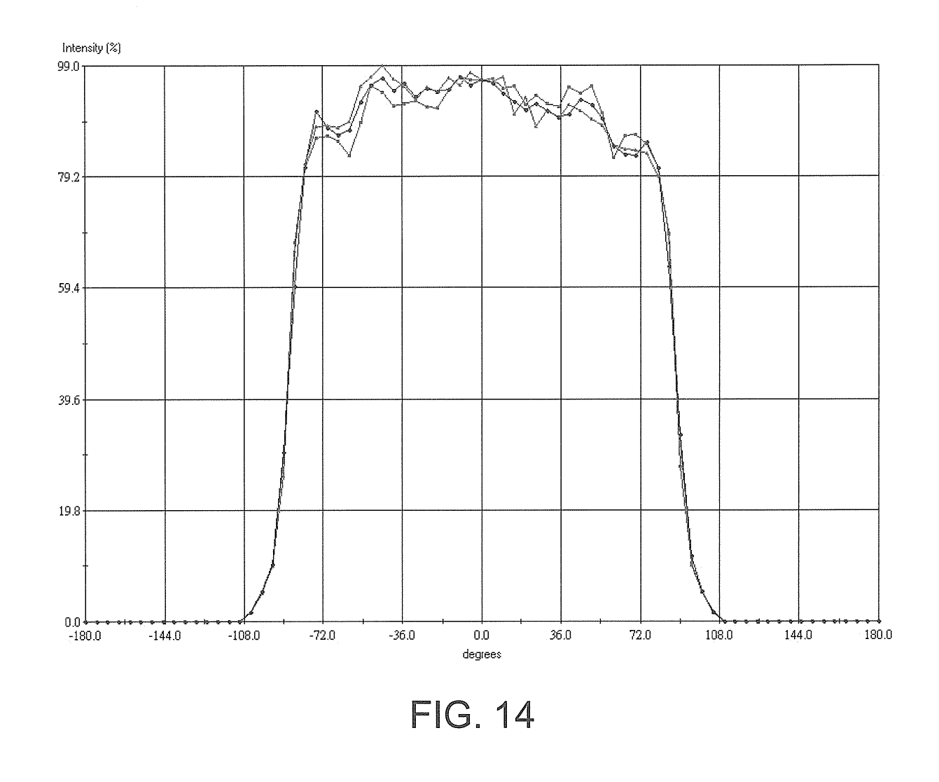

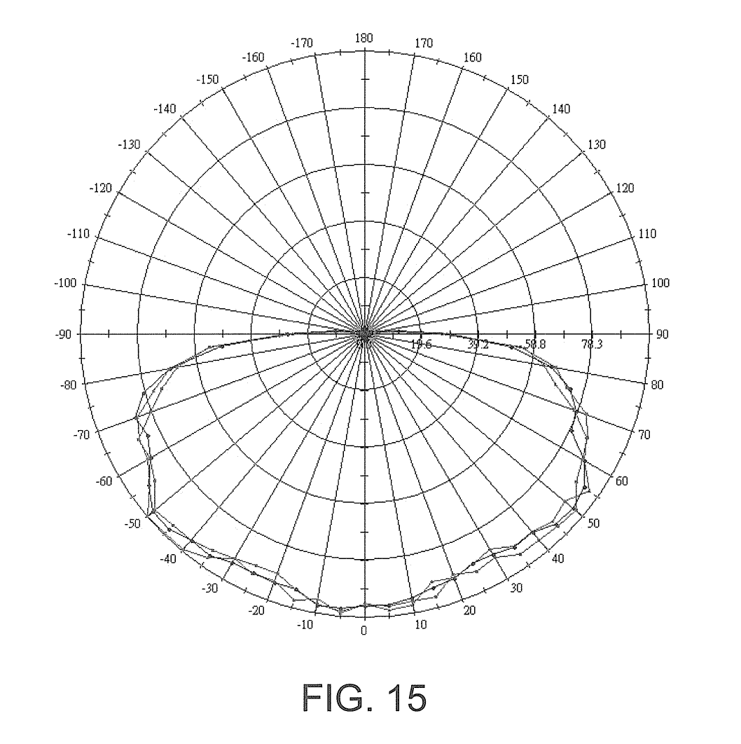

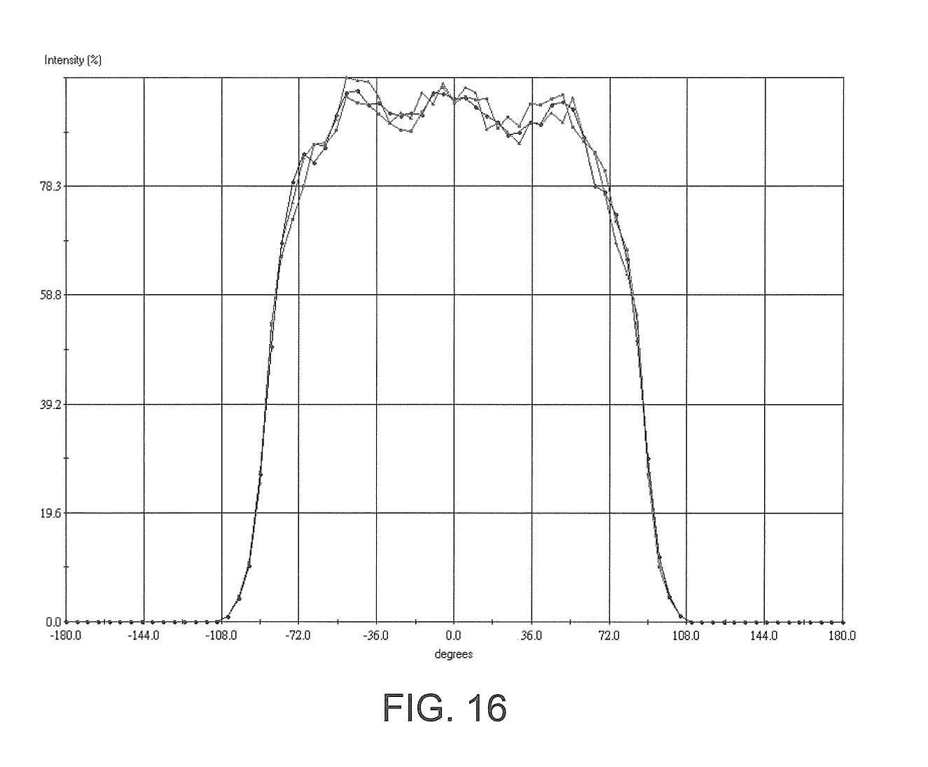

FIG. 13 is a polar radiation view illustrating the beam shape when a lamp having the lens depicted in FIG. 11 is applied. FIG. 14 is a cross-sectional view illustrating the beam shape when a lamp having the lens depicted in FIG. 11 is applied. With reference to FIG. 13 and FIG. 14, the material of the lens 300 as shown in FIG. 13 and FIG. 14 is the same as the material of the lens as shown in FIG. 6 and FIG. 7, i.e., the lens 300 depicted in FIG. 13 and FIG. 14 is made of PC as well. In comparison with the lamp described in the first embodiment, the lamp having the lens 300 of this embodiment has relatively uniform luminance within the range of the viewing angle. FIG. 15 is a polar radiation view illustrating the beam shape when the lamp has the lens that is made of PMMA. FIG. 16 is cross-sectional view illustrating the beam shape when the lamp has the lens that is made of PMMA. In comparison with the lamp described in the first embodiment and shown in FIG. 8 and FIG. 9, the lamp having the lens 300 described in this embodiment and shown in FIG. 15 and FIG. 16 has relatively uniform luminance within the range of the viewing angle, and the light with relatively uniform luminance can be emitted from the top of the lamp 200 (shown in FIG. 4).

The first light incident surface described in the first and the second embodiments is an inclined surface or a plane, for instance. However, people having ordinary skill in the art are able to modify the shape of the lens of the invention, so as to satisfy the requirement for wide viewing angle, favorable beam shape, and desirable luminance. For instance, the first light incident surface can be the curved concave.

In the first embodiment and the second embodiment, the concave stands for curving toward the inside of the lens, and the convex stands for bulging toward the outside of the lens. However, people having ordinary skill in the art are aware that the concave and the convex are relative terms in the above embodiments and should not be construed as limitations to the descriptions in the embodiments or to the drawings.

In light of the foregoing, the lens of the invention has the simple look and is easy to make, and thus the manufacturing costs of the lens are rather low. Moreover, when the lens and the directional LED light source are both applied, the range of the viewing angle of the LED light source can be enlarged. As such, the LED light source can be used in the decorative lamp and can be extensively applied.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A lens, a light emitting diode light source being suitable for being configured within the lens, the lens having a curved light incident surface, a first light incident surface, a first light emitting surface, and a second light emitting surface, wherein the first light incident surface surrounds the curved light incident surface, the curved light incident surface and the first light incident surface together constitute an accommodation space to accommodate the LED light source, the first light emitting surface is located above the curved light incident surface, the second light emitting surface is located at an outer side of the lens and corresponds to the first light incident surface located at an inner side of the lens, and the second light emitting surface surrounds the first light emitting surface, wherein the curved light incident surface is a curved concave.

2. The lens as claimed in claim 1, further comprising an auxiliary surface surrounding the first light incident surface.

3. The lens as claimed in claim 2, wherein the auxiliary surface surrounds a circumference of the first light incident surface, and a diameter of the auxiliary surface is an outer diameter of the first light incident surface.

4. The lens as claimed in claim 1, wherein the first light incident surface is a plane, an inclined surface, or a curved surface.

5. The lens as claimed in claim 1, wherein the auxiliary surface is a circumferential surface of the first light incident surface.

6. The lens as claimed in claim 1, wherein the second light emitting surface has a first portion and a second portion, an inner diameter of the second portion is equal to an outer diameter of the first portion, and an outer diameter of the second portion is greater than the inner diameter of the second portion.

7. The lens as claimed in claim 6, wherein the first portion of the second light emitting surface is an inclined surface or a curved concave.

8. The lens as claimed in claim 6, wherein the second portion of the second light emitting surface is an inclined surface or a curved surface.

9. A lamp comprising:
a lampshade;
a base assembled to the lampshade;
a lens configured on the base and located in the lampshade, the lens having a curved light incident surface, a first light incident surface, an auxiliary surface, a first light emitting surface, and a second light emitting surface, wherein the first light incident surface surrounds the curved light incident surface, the auxiliary surface surrounds the first light incident surface, the curved light incident surface, the first light incident surface, and the auxiliary surface together constitute an accommodation space, the first light emitting surface is located above the curved light incident surface, the second light emitting surface is located at an outer side of the lens and corresponds to the first light incident surface and the auxiliary surface that are located at an inner side of the lens, and the second light emitting surface surrounds the first light emitting surface, wherein the curved light incident surface is a curved concave; and
a light emitting diode light source configured in the accommodation space of the lens.

10. The lamp as claimed in claim 9, wherein the auxiliary surface surrounds a circumference of the first light incident surface, and a diameter of the auxiliary surface is an outer diameter of the first light incident surface.

11. The lamp as claimed in claim 9, wherein the first light incident surface is a plane, an inclined surface, or a curved surface.

12. The lamp as claimed in claim 9, wherein the auxiliary surface is a circumferential surface of the first light incident surface.

13. The lamp as claimed in claim 9, wherein the second light emitting surface has a first portion and a second portion, an inner diameter of the second portion is equal to an outer diameter of the first portion, and an outer diameter of the second portion is greater than the inner diameter of the second portion.

14. The lamp as claimed in claim 13, wherein the first portion of the second light emitting surface is an inclined surface or a curved concave.

15. The lamp as claimed in claim 13, wherein the second portion of the second light emitting surface is an inclined surface or a curved surface.

16. The lamp as claimed in claim 9, further comprising a light source lens configured on the light emitting diode light source.
